(19) United States
(12) Patent Application Publication
(10) Pub. No.: US 2002/0070166 A1
(43) Pub. Date: Jun. 13, 2002

(54) Sample purification on a microfluidic device

(75) Inventor: Christopher J. Backhouse, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Board of Governors of the University of Alberta

(21) Appl. No.: 10/013,783

(22) Filed: Dec. 7, 2001

Related U.S. Application Data
(60) Provisional application No. 60/251,521, filed on Dec. 7, 2000.

(51) Int. Cl. B01D 11/00

(52) U.S. Cl. 210/634; 210/748; 210/767

(57) ABSTRACT

A method of sample separation begins with the step of moving product and contaminant along a first channel in a first direction at different speeds for the product and contaminant until contaminant separates from the product and is lost by dilution in a waste well. Then the direction of movement of the product and contaminant is reversed to separate product from the contaminant. After product is separated from contaminant it may be detected using conventional detectors. To ensure effective dilution of contaminant, it is preferred that there be a delay or pause between forward movement of the sample and reverse movement.

### CROSS-REFERENCE TO RELATED APPLICATIONS

This application claims the priority of U.S. provisional application No. 60/251,521 filed Dec. 7, 2000, the disclosure of which is hereby incorporated by reference.

### BACKGROUND OF THE INVENTION

Since the first conceptual [1, 2] and applied [3-5] examples of miniaturised total analysis systems (μTAS) were demonstrated, research in this field has focused on implementing different components of what might be considered to be a complete analytical protocol: precolumn reactors [6], injectors [3], separations by a variety of methods [4, 5, 7-16], postcolumn reactors [17] and detectors [18-20]. All references cited in square brackets are listed at the end of this patent document. As the technology for these components becomes more robust and proven, bioscience researchers are beginning to participate in TAS development, in an effort to capitalize on the promise of low sample consumption, rapidity of analytical protocols [21], and serial [22] and/or parallel [23] integration of these protocols. Examples of bioseparations successfully transferred onto microfluidic chips include capillary electrophoresis of DNA molecules [24, 25], micellar electrokinetic capillary chromatography [26, 27], and immunoassays [28, 29].

In life science laboratories, purification methods are commonly required for the removal of small, high mobility components such as salts, fluorescently labeled dNTPs (fdNTPs) and primers. In protocols involving the analysis of products from PCR involving fdNTPs, sample purification is required prior to further processing, otherwise the unincorporated dNTPs impair effective separation [30]. The required sample purification is typically done in an additional processing step in a centrifuge (e.g., Qiagen columns) [30, 31] or by using ethanol precipitation [32]—methods not readily implemented upon a microfluidic chip. Similarly, salts in a DNA sample have been noted to significantly decrease the quality of electrophoretic separations [33, 34]. For this and other reasons (e.g., salt removal in preparation for mass spectrometry), in many macroscopic protocols it is a standard procedure to remove salts from a sample of DNA by precipitating the DNA with ethanol, followed by resuspension of the DNA in a fresh, lower salt solution (e.g., [34]). Again, this procedure would be difficult to implement upon a microchip. In either of these situations, the high mobilities of the salts or fdNTPs make the sample preparation technique presented here suitable for such purifications while being readily implemented on currently available microchips.

Although it has been demonstrated that there is no loss of electrophoretic performance in microfluidic channel-based devices as compared with those that are capillary-based [35], the challenge now is to attain higher levels of integration on a microchip. Many recent developments in microfluidic devices are aimed towards the integration of sample preparation and electrophoretic separation on a single microchip. One of the major advances in integration, and representative of the currently available technology, is the ability to perform the PCR to prepare an amplified DNA sample on-chip, followed by electrophoretic analysis [22, 36-39]. In order to allow increased levels of integration the microfluidic technology must provide enhanced sample preparation capabilities on-chip.

### SUMMARY OF THE INVENTION

There is therefore provided in accordance with an aspect of the invention, a method of sample separation. The method comprises the steps of moving product and contaminant along a first channel in a first direction at different speeds for the product and contaminant until product and contaminant enter a waste well. Then the direction of movement of the product and contaminant is reversed to separate product from the contaminant. After product is separated from contaminant it may be detected using conventional detectors. To ensure effective dilution of contaminant, it is preferred that there be a delay or pause between forward movement of the sample and reverse movement. The method has particular utility for sample obtained through polymerase chain reaction, such as when the product is DNA and the contaminant is PCR raw material. For many samples, separation by application of an electric potential along the channel is preferred. Separation of the sample may also be followed by a further separation along a channel at right angles to the initial injection channel.

### BRIEF DESCRIPTION OF THE FIGURES

There will now be described preferred embodiments of the invention by way of example only, without intending to limit the claims to the specific embodiment disclosed, in which like reference characters denote like elements and in which:

FIG. 1 is a top plan view of a conventional glass microchip used for capillary electrophoresis available from Micralyne Inc. of Edmonton, Alberta, Canada.

FIGS. 2A-2G are schematic plan views showing events during injection and reversed injection of PCR sample in a method according to the invention, in which FIG. 2A shows sample loaded into sample well, no potentials yet applied, FIG. 2B shows sample being injected with higher mobility primers leading (on right), FIG. 2C shows sample fully loaded into injection channel, now entering sample waste well on right where infinitely diluted, FIG. 2D shows sample moving left with trailing product (reversed injection), FIG. 2D shows a separation from an initial sample containing only primers (after a forward injection), FIG. 2E shows a separation from an initial sample containing both primers and product DNA (after a forward injection) and FIG. 2G shows separation from an initial sample containing only product DNA (after a reversed injection).

FIG. 3 is a graph showing fluorescence recorded in the injection channel with movement of the DNA towards the sample waste well (0-60 s), with detection at the intersection. The stepwise increase of the fluorescence versus time represents first the arrival of the fluorescently labelled primers and then the arrival of the product DNA (in addition to the primers). From 180 to 240 s the signal is the fluorescence recorded in the injection channel when moving the DNA back to the sample well. A two-step ‘peak’ from 182-188 s precedes the trailing edge step at 195 s.

FIGS. 4 and 5 are graphs showing DNA separations after successive movements of the DNA in the injection channel (FIG. 4) towards the sample waste well and (FIG. 5) (in reverse) towards the sample well. The fluorescence was detected in the separation channel, 13 mm from the intersection of the injection and separation channels. The graph inset within is the signal from a separation of purified PCR product; no primer signal is evident.

### DETAILED DESCRIPTION OF PREFERRED EMBODIMENTS

In this patent document, the word “comprising” is used in its non-limiting sense to mean that items following the word in the sentence are included and that items not specifically mentioned are not excluded. The use of the indefinite article “a” in the claims before an element means that one of the elements is specified, but does not specifically exclude others of the elements being present, unless, unless the context clearly requires that there be one and only one of the elements. The word “sample” is used to describe the material, including product and contaminant, that is to be analyzed. Product is the portion of the sample that is of interest and is to be retained for analysis. Contaminant is the portion of the sample that may interfere with the analysis of the product and is to be removed from the sample. Contaminant may be for example raw material from PCR, namely primers or nucleotides, or salts. The term waste well is used to differentiate the well in which dilution occurs from the well from which the sample is provided.

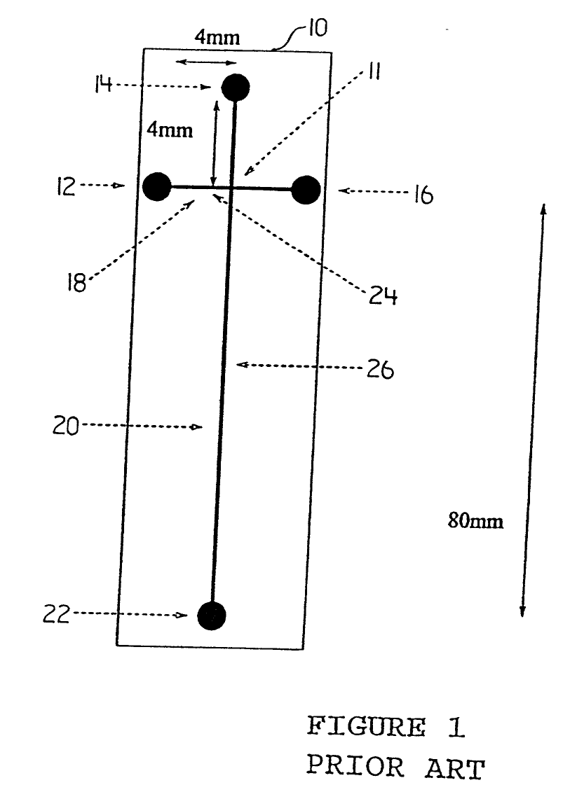

A standard design of a microchip capable of both injection and electrophoretic separation is shown in FIG. 1. FIG. 1 shows a microchip 10 with buffer well 12 about 4 mm from intersection 11, sample well 14 also about 4 mm from intersection 11, sample waste well 16, injection arm 18 separation channel 20, about 84 mm long, buffer waste well 22, frontal detection point 24 and conventional method detection point 26. Of the two intersecting channels 18, 20, the first channel 18 serves to electrophoretically load the sample (short channel in FIG. 1) from the sample well 12. The sample within the intersection 11 of the two channels 18, 20 can be separated electrophoretically along the second channel 20 by changing the applied electric potentials. The channel intersection 11 provides a precisely defined injection plug, typically 50-100 μm in length. However, intersecting channels require considerable space on a microchip, thereby restricting the number of devices that can be manufactured on a substrate.

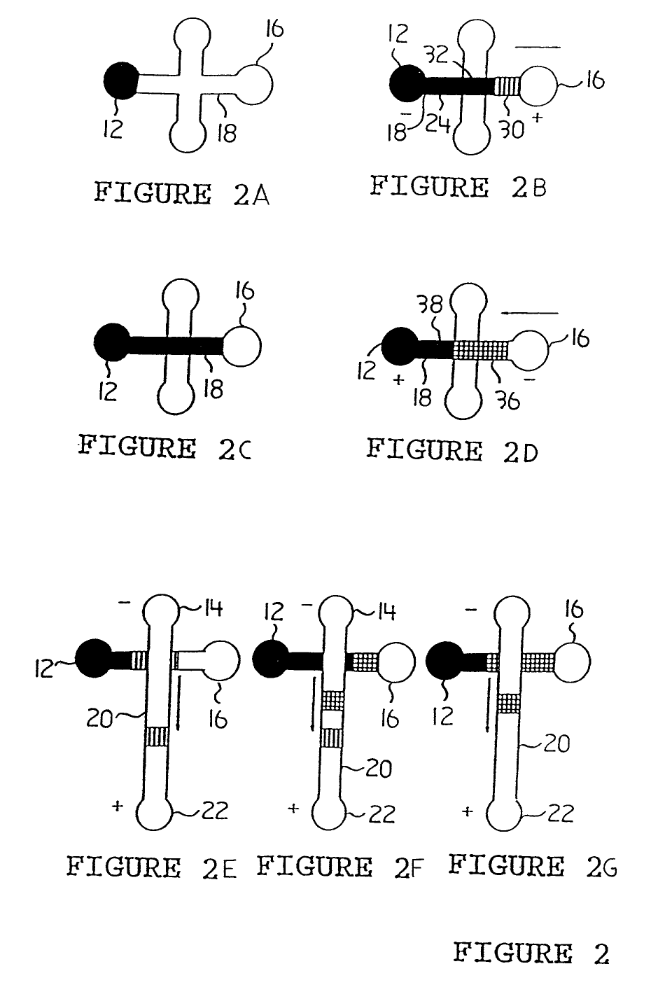

Frontal analysis, which is carried out in a single channel, may be carried out on a microchip. Use of a single channel eliminates space-consuming intersections. FIGS. 2A and 2B illustrate how a frontal analysis may be carried out. FIGS. 2A-2G illustrate method steps carried out on the microchip shown in FIG. 1, but the method steps of FIGS. 2A-2D may be carried out on a microchip having a single channel, with detection at the detection point 24 shown in FIG. 1. In FIG. 2A, sample well 12 is loaded with sample from a PCR reaction. Black is used to represent the sample, which contains product, primer and salts. The injection channel 18 is loaded with a conventional sieving matrix. Since the sieving matrix hinders diffusion, the sample does not move into the microchannel 18 until a voltage is applied. During the injection phase (FIG. 2B), a potential is applied between the sample well 12 and sample waste well 16 to drive product and primer along the channel towards the sample waste well 16. The primers (and salts) with their higher electrophoretic mobilities will lead the way toward the sample waste well 16, creating a leading region 30 with primers only and a trailing region 32 with both product and primers.

In this frontal analysis method, the results of the PCR may be analysed by monitoring a fluorescence signal from the product versus time from a point 24 in the injection channel 18. The detection is carried out using conventional detectors located at the detection point. Such detectors are available from many companies, including Micralyne Inc. of Edmonton, Alberta, Canada. This method is suitable for some medical diagnostics, which are based on the presence or absence of an amplifiable sequence (e.g., [22]), and allows both a higher channel density per chip and higher signal-to-noise ratio than do common protocols involving intersecting channels.

The sample wells on a microfluidic chip typically contain vastly more (ca. 3000-fold excess) sample than is needed for a single microchip-based analysis. This means that the sample well 12 can be considered to be an infinite reservoir. A frontal electrophoretic separation from any such a reservoir can readily isolate the faster moving components from the remainder of a sample but cannot isolate the slower component (as shown in FIG. 2B). In some cases, contaminants such as salts and primers can be separated electrophoretically, but often (e.g., [33]) the contaminants prevent efficient separation, leading to dilution or loss of sample. A method of removing the contaminants is needed that avoids degradation of the product. This is a significant problem in applications that require the isolation (purification) of the slower component prior to further processing and must be overcome in order to attain higher levels of integration on microchips.

One approach to isolating the slower components requires only that one valve-off the infinite reservoir during an injection so that unpurified sample no longer enters the injection channel 18. The slower components then trail behind in the ongoing injection while not decreasing their concentration. Unfortunately, microfluidic valve technologies are considerably more complex than the basic microfluidic technology and, to further complicate matters, any valving of sample must not prevent other charge carriers from entering the channels (otherwise the current, and hence the separation, would cease). A method of selective valving is therefore required—one that valves-off the DNA, but not the ions making up the running buffer.

As shown in FIGS. 2A-2D, a process of sample separation starts with moving a sample of product along with contaminant (primer and salts) along channel 18 from sample well 12 to sample waste well 16 by application of a potential between the wells 12, 16. The product and contaminant move at different speeds until contaminant separates from the product and is lost by dilution in the waste well 16 (FIG. 2C). Dilution may also occur for example by removal of material at the waste well, for example by rinsing of the waste well. Next, preferably after a delay, the potential applied across the wells 12, 16 is reversed to reverse the direction of movement of the product and contaminant. Reversal of the direction of movement separates product from the contaminant (FIG. 2D) resulting in product at 36 being separated to be available for detection in the channel 18. A second stage of separation may be obtained by isolating the separated product by drawing the separated product into a channel 20 intersecting the channel 18 and applying a potential between the wells 14 and 22.

Thus, in a prolonged electrophoretic movement of a sample consisting of DNA molecules of two different electrophoretic mobilities (such as the primers and product in PCR), the sample that enters the sample waste well will be diluted (FIG. 2C) to an extent that is dependent on the delay between reversal of direction of the movement of the sample. With sufficient time, dilution becomes so large, effectively infinite, that the contaminants are essentially lost in the sample waste well 16.

By filling the sample waste well with running buffer alone rather than sieving matrix this diffusion is sufficient. Hence, upon reversal of the voltages in the injection channel, the sample within the injection channel will reverse direction while the sample in the waste well will not return. In this way, the device acts as a one-way pass valve or gate for DNA as indicated in FIG. 2D. In FIG. 2D, the trailing edges of the two components of the retreating sample separate to create two regions: one which is both primer and product (leading and leftmost at 38) and the other of which is product alone (trailing and rightmost at 36). The gating effect is critical. Without it, the lower mobility DNA strands cannot be isolated.

### EXAMPLE

This invention has particular utility for applications where DNA molecules of different sizes, larger product and shorter primers, are produced by PCR (Polymerase Chain Reaction). As an example, we performed PCR on a portion of the SCO1 gene from the yeast nuclear genome using 24-base primers selected to give a 319 bp product. The reaction used primers labeled at their 5′-ends with the fluorophore Cy5 (Synthetic Genetics, San Diego, Calif., USA). The PCR was carried out with the following cycling conditions: 94° C. for 2 min followed by 35 cycles of 94° C. for 1 min, 55° C. for 1 min and 72° C. for 3 min. A final extension step of 72° C. for 5 min was included. PCR product (2 μL) was mixed with template suppression buffer (5 μL, TSR, Part #401674, PE Biosystems, Foster City, Calif., USA), heated to 95° C. for 3 min, and then snap cooled for 1 min in an ice-water bath to provide single-stranded DNA molecules.

The Microfluidic Tool Kit (μTK) manufactured by Micralyne (Edmonton, Canada) was used for the microchip manipulations described here, although microfluidic systems from other manufacturers may be used. The μTK consists of a laserinduced fluorescence (LIF) inverted epiluminescent confocal microscope with photomultiplier tube (PMT), integrated modular high-voltage power supplies and control system. The selected LIF system provides excitation at a wavelength of 635 nm and detection at 670 nm (for Cy5). The μTK can be operated by means of either a compiled LabView interface (supplied by Micralyne) or under a program written in C, with the same functionality under either system. The microchips used here were the simple cross injector design manufactured by Micralyne (nominal channel dimensions of μm wide and 15 μm deep, as shown in FIG. 1). With programmable PMT gain, the μTK acquired the LIF signal at 50 Hz and these data were recorded to hard disk on the host computer by the control program. Following the run, spurious, single point peaks were identified and smoothed by averaging any peaks greater than 2 standard deviations from the local mean of 5 points. Further data analysis was performed by applying the 21-point, second order, Savitsky-Golay method [40] to smooth the data. This processing did not affect the peaks due to the passage of DNA: in successive runs with the same sample the peaks from DNA were consistently present. The smoothing program wrote a Maple (Waterloo Software, Waterloo, ON) script to display and further analyze the data in an automatic fashion. For electrophoresis, the channels of the microchip were loaded with the sieving medium POP-6 (PE Biosystems, part #402837) by using a 1 mL syringe to apply pressure (ca. 300 psi) at the loading well (FIG. 1) until the microchannels were completely filled. Subsequently, 1 μL of POP-6 was added to the sample waste well and a 1.5 μL aliquot of the single stranded PCR mix was transferred to the sample well. Genetic analyzer buffer (PE Biosystems, part #402824) was added to all of the wells, giving a total volume of 3 μL per well. This leaves a sharp interface the sample waste well—the sieving matrix in the injection microchannel ends abruptly at the sample waste well, with the well itself filled with running buffer.

To perform frontal analysis, we applied −400 V on the sample well of a freshly loaded chip with the sample waste well grounded (FIG. 1) for 60 s (with the other wells electrically disconnected). This is as an injection step, as it moves sample from the sample well into the microchip. Detection took place at the intersection (4 mm from the sample well). To move the sample back towards the sample well from inside the microchip we used the opposite polarities, with −400 V on the sample waste well and with the sample well grounded. This is a reversed injection step. Again, detection took place at the intersection (4 mm from the sample well).

To perform separations, an initial injection step (as described above) was used to move sample toward the intersection. Conventional orthogonal zone separations were then run for 90 s to separate whatever sample had reached the intersection by applying a negative voltage to the buffer well (−5000 V), with the buffer waste well held at ground and the sample and sample waste wells electrically disconnected. The fluorescence detection took place at detection point 26 in the separation channel 20 (FIG. 1) 13 mm below the intersection 11.

The microchip was freshly loaded and a 60 s injection of sample was made. Based on the DNA mobilities in the frontal analysis, after ca. 50 s of injection the primers and product filled the injection channel 18 and had entered the waste well 16. We then performed a reversed injection after a pause of 2 min. This pause gave sufficient time for those DNA molecules that had entered the sample waste well 16 to diffuse into the essentially infinite volume of running buffer.

To investigate the degree to which the PCR product was isolated, a series of separations was made in order to sample the contents of the injection channel at the intersection after successive steps of injection and reversed injection. First, a microchip was cleaned by flushing deionised water through the channels for ca. 2 min by means of a 1 mL syringe. The chip was then dried, reloaded and a series of 10 s injections was made, each followed by an orthogonal 90 s zone separation. After a total of 60 s of injection, a series of 3 s reversed injections was made, each followed by an orthogonal 90 s zone separation. The series of reversed injections and separations was repeated until the subsequent separations showed no more peaks (i.e., no DNA present in the intersection).

### RESULTS

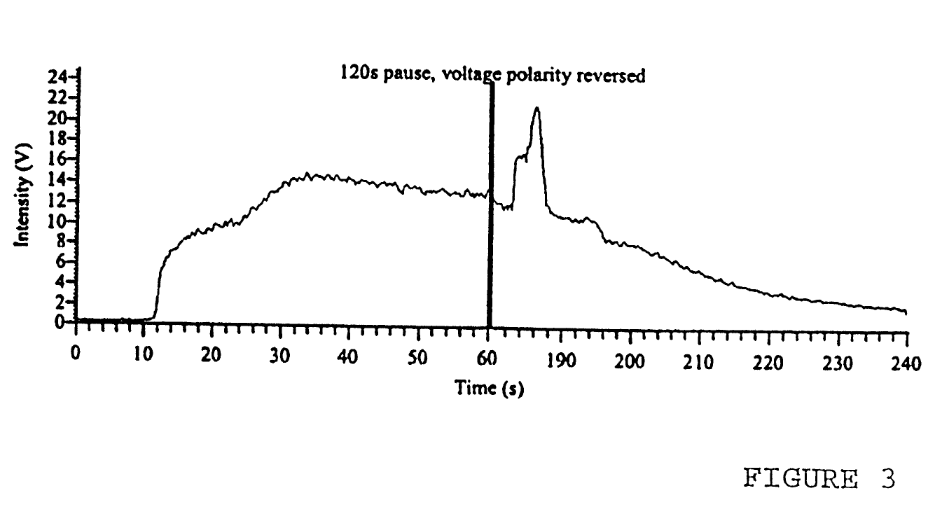

FIG. 3 depicts the injection of a PCR sample for 60 s with the detection at the intersection (a distance of 4 mm), followed by a 120 s pause and then a reversed injection from 180 s to 240 s. This figure shows a two-step increase in the fluorescence signal at 12 s and 24 s—a frontal analysis. The first step (ca. 12 s) represents the arrival of primer corresponding to an electrophoretic mobility of 6.6 10⁻⁵ cm²/Vs. For the second step (ca. 24 s), a mobility of 3.3 10⁻⁵ cm²/Vs is calculated for the product DNA.

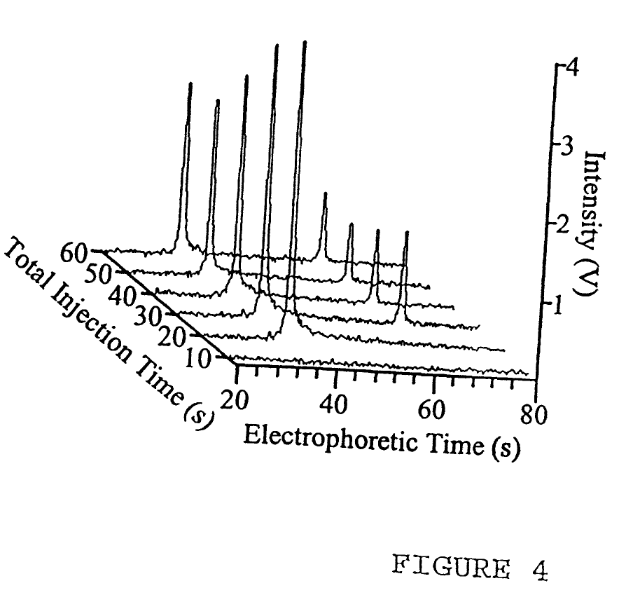

As shown in FIG. 4, after 10 s of forward injection, no peaks appeared in the subsequent orthogonal zone separation (corresponding to the situation depicted in FIG. 2a), indicating that no fluorescently labeled DNA had arrived at the intersection 11. After the second 10 s interval of forward injection, a peak appears at 36 s (representing 26 s of separation, the first 10 s being from the injection step) indicating that the primer DNA had reached the intersection 11 by the time the separation step began (corresponding to FIG. 2e).

After ten more seconds of injection (a total of 30 s), a new peak, this one due to the product DNA, emerges at 64 s in orthogonal zone separations (corresponding to FIG. 2f). The two peaks (primer and product DNA) remained present after each of the following three forward injections. From FIG. 3 it is apparent that after ca. 12 s and 24 s the primer and product have reached the intersection (the halfway point). After 24 s and 48 s then, the primer and product will have reached the sample waste well 16. Hence, after 60 s of injection the injection channel 18 contains both primer and product DNA throughout and some primer and product have entered the waste well 16.

FIG. 3 depicts the decrease in the fluorescence signal during a reversed injection from 180 to 240 s. In an ideal case, any sample entering the waste well 16 during an injection step would be lost completely and, during a subsequent reversed injection, stepwise decreases in signal would be seen: the reversed fluorescence signal would start high (with fluorescence from both product and primer DNA), then drop to a lower value when only the product DNA was present in the trailing DNA and finally down to the background baseline level when no more DNA remained. As can be seen in FIG. 3, du ring reversed injection there first occurs a two-step ‘peak’ at 182-188 s, followed by a stepwise decrease at 195 s, a second more diffuse ‘step’ at 202 s followed by an exponential-like decay. These features are reproducible in their general form, and while these phenomena have not been fully characterised, they are consistent with the particular features of the device and protocol. Without a pause to allow for diffusion, the step-like effects described here were weaker and with longer pauses became more pronounced (data not shown). The 2 min pause is long enough to see these effects while being short enough to avoid the effects of evaporative loss from the microchip.

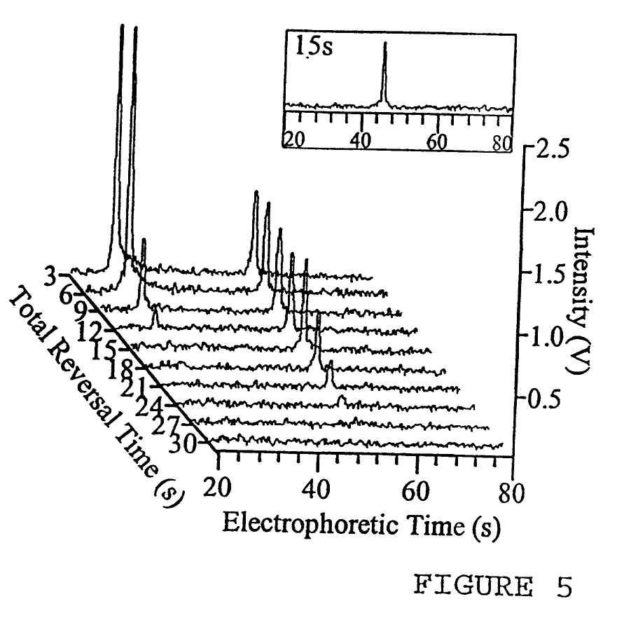

As shown in FIG. 4, with successive injections and orthogonal zone separations we are able to isolate either the primers alone (FIG. 4 with forward injections), primer and product together (FIG. 4 or 5), or product alone (FIG. 5 with reversed injections). After the first 3 s interval of reversed injection, the subsequent separation showed both the primer and product peaks (corresponding to FIG. 2F). Following successive reversed injections, the relative intensity of the primer peak was diminished. After a cumulative reversed injection time of 15 s (corresponding to 195 s on FIG. 3) only the product peak is apparent (corresponding to FIG. 2G). In later steps this product peak diminished in size and disappeared, indicating that the trailing product had passed the intersection 11 of the channels 18, 20.

Although the underlying mechanisms may not be fully understood, a purified product is reproducibly obtained. During the forward injection phase, the DNA will move through the injection channel 18 and enter the sample waste reservoir 16. At the end of the microchannel 18, the dramatic widening into the sample waste well increases the cross sectional area by a factor of 10³, hence dropping the applied field by the same factor. The DNA ions arrive at the waste well 16 and slow dramatically, becoming concentrated near the channel-well interface. An immediate reversal of the applied potential would move these molecules back into the microchannel without substantial loss. During the pause however, this high concentration of molecules diffuses into the reservoir following Fick's laws of diffusion [41]. The subsequent reversal of fields then samples a far more dilute population of DNA molecules at the sample waste end 16 of the microchannel 18.

Debye screening [42] refers to the shielding of an ionic charge by small displacements in the background ions, or “ionic cloud”. The Debye length is the characteristic length of this shielding effect, on the order of 10-1000 mn for typical microchip conditions (e.g., [42]). Once DNA molecules have diffused several Debye lengths into the sample waste well 16 their charge will be shielded and they will be insensitive to any externally applied electric fields. After forward injection we would expect the DNA to be concentrated within a distance from the end of the microchannel 18 that is comparable to the Debye length. This situation is not unlike that encountered in electrochemistry (e.g., [43]) near an electrode within a sample solution.

The diffusion constant of DNA strands of this length in a sieving medium are on the order of 10⁻⁷ mm²/s, and approximately 2 orders of magnitude larger in free solution [44]. A complete solution of the diffusive behaviour in this geometry would seem to require a numerical simulation, however, to verify that, the phenomena are of the correct magnitude to explain these results, we make a number of simplifications. Applying Fick's second law of diffusion in one dimension, with all the DNA concentrated within a Debye length (1000 nm) of the end of the channel 18, and having the free solution diffusion constant given above (10⁻⁵ mm²/s), we would expect the normalised concentration to change by 10% in only 0.01 s. Hence, on a time scale of seconds, diffusion can be expected to cause a substantial change in the concentration (i.e., dilution) at the end of the channel in the waste well 16. It is therefore feasible that diffusion moves the accumulated DNA away from the microchannel 18 and beyond the Debye length. Upon reversal of the injection, this diffused DNA is shielded and insensitive to applied potentials. This introduces a significant irreversibility that leads to DNA being prevented from returning from the sample waste well 16. This valving or gating effect may not be perfect in that even during reversed injection, diffusion will return some DNA to the microchannel 18. We estimate that the primer concentration has been decreased by a factor of at least 100. We think of this as a mechanism of molecule-specific valving with the reverse movement of DNA being 1/100th that of the forward movement of DNA. This is comparable to many one-way valves (e.g., flap valves) in which forward to reversed flow ratios are often 100:1 to 10 000:1.The reversed flow which we expect from diffusion may well be smaller than that estimated here.

A design of molecule-specific valving has been reported by Khadurina et al. [45], in which a thin porous silicate layer was introduced into a microfluidic device. This silicate layer was used to block the passage of DNA, while allowing the passage of other ions. After a period of forward injection through the silicate layer the fields were reversed and the DNA, substantially concentrated, was then extracted. Although the present method does not lead itself to concentration of the sample, it does allow for the selective removal of one type of DNA while retaining another and requires no extra processing steps in chip manufacture.

The mobilities of the primer and product peaks as determined in the separation channel are 8.4 10⁻⁵ cm²/Vs for the primer and 4.05 10⁻⁵ cm²/Vs for the product—somewhat higher than the ones calculated above for sample injection. This difference is due in part to uncertainties (estimated at 10%) in positioning the LIF optics. Microchip designs should incorporate distance markers for improvements in this positioning accuracy. It is also possible that the significant change in sample composition has affected the separation: others have found that salt concentrations significantly affected their separations [33, 34].

The two-step peak at ˜185 s in FIG. 3 may result from sample diffusion into the long channel during the initial injection or the 2 min pause between the forward and reverse directions of DNA migration. If one considers the amount of sample along the axial coordinate of the injection channel, diffusion into the separation channel during the pause represents an increase in sample at that axial coordinate, and depletion on either side. Correspondingly, when the voltage is reversed (bold vertical line in FIG. 3), the fluorescence, which was observed just left of the intersection 11, is immediately seen to decrease (depletion), then the peak from all the sample at the nearby intersection 11 is observed (first primer, then primer + product, as seen in the two steps), and lastly the trailing edges for the two sample components (first primer, then product) are seen as the features at 195 and 202 s.

The less-than-stepwise appearance of the retreating sample components (FIG. 3, from 180 to 240 s), as well as the two-step peak described above, are not fully understood; these phenomena are currently being investigated. Our candidate mechanisms are: (i) diffusion into the long channel during the injection and pause (described above) that produce the two-step peak. (ii) Biases in ion depletion occurring during the forward and reverse injection stages. This situation is not unlike those used in microchip implementations of isotachophoresis [46, 47] in that a variation in ion concentrations could lead to a variation in electric field within the microchannel that may in turn lead to a concentration of the sample, thereby producing the two-step peak. (iii) Biases in ion depletion occurring during the forward and reverse injection that alter the sieving properties of the matrix so that well-defined frontal zones are no longer possible. Since DNA mobilities are known to be affected by salt concentrations and running buffer, it seems likely that a method that causes a drastic alteration in these concentrations is likely to lead to a drastic change in the separation properties of the matrix. These alterations are expected to affect only the operations in the injection channel and are likely to produce poorly defined fronts, possibly explaining the exponential-like decay in signal seen in FIG. 3 from 195 s and on.

During the 2 min pause we expect that both the primer and product will diffuse into the sample waste well, but residual amounts will remain in the vicinity of the end of the microchannel (within a Debye length) and hence be recoverable. This recovery of the DNA very near the channel may be the source of the exponential-like decay of the signal upon reversal. Even so, this residual signal is expected to represent mainly product DNA since the primers diffuse away more rapidly. Upon reversal we expect little DNA to reenter the microchannel from the sample waste well—in other words, the DNA has passed through a gate or one-way valve. During reversal the movement of the DNA within the injection channel would be expected to lead to a two step decrease in signal as the last of the primers and then the last of the product pass the detection point (FIG. 2D). We believe that the step due to the passage of the last of the primers is seen at 195 s (after˜15 s of reversed separation). Although this would represent a slightly lower mobility than was seen during the injection phase, this difference could be attributed to a change in the ion concentrations seen upon reversal of the injection (e.g., [33, 34]). The occurrence of this step strongly suggests that a valving or gating mechanism is present.

The exponential tail seen in FIG. 3 (195 s and greater) seems therefore to consist entirely of product DNA. The lack of a second step may indicate that a change in the ion concentrations in the sieving matrix now prevents electrophoretic transport with a well defined mobility. To corroborate this, the orthogonal separations were used to determine the relative concentrations of primer and product in the injection channel. Separations performed with 0-12 s of total reversed injection time (correspondingly 180-192 s in FIG. 3) show both product and primer peaks. In contrast, reversed injection times greater than 15 s (corresponding to greater than 195 s in FIG. 3) show only the product DNA—this supports our interpretation that the first step (at 195 s) represents the passage of the last of the primer DNA. Hence the primer peak, which was initially several times stronger than the product peak (as seen in FIG. 5), has become undetectable.

In conclusion, we have demonstrated a method of purifying a sample consisting of two labeled species of DNA, however, the technique would apply equally well to any situation involving one or more low-mobility species of interest mixed with higher mobility species. We expect that this technique will be of interest for use in sample preparation and purification, particularly in conjunction with salt removal. Although a method has been reported which would allow the purification of samples based on diffusion properties in a complex asymmetric system [48], the present method could be implemented on even the simplest microfluidic structures. Other possible applications of this technique include improvement of signal-to-noise in diagnostics through the isolation of PCR product from primers and purification of PCR productas part of protocols such as nested PCR, cloning or sequencing.

Although we are continuing to investigate the lack of the ideal stepwise behavior during the reverse injection, the technique of molecular gating is readily applicable to the task of removing excess salts, fluorescently labeled dNTPs and primers. The method represented here is suitable for the microchip removal of any high-mobility component and is readily implemented on currently available microchips. As such it is likely to be useful in the coming integration of more complex protocols upon microfluidic chips.

The sample may be obtained from a PCR step carried on in conventional manner off chip or on chip. When the PCR step is carried out on chip, it may be carried out in a well using conventional methods, in which the entire chip is thermally cycled, or in a channel in which the PCR components are thermally cycled by joule heating, such as by irradiating the PCR components, or an in channel method in which the PCR components are moved along a serpentine channel through differentially heated zones of the chip. Methods of carrying out PCR, both on chip and off chip, are well known.

Immaterial variations on the embodiments disclosed here are intended to be included within the scope of the invention.

### REFERENCES

[1] Manz, A.,Graber, N., Widmer, H. M., Sensors Actuators 1990, B1, 244-248.

[2] Manz, A., Fettinger, J. C., Verpoorte, E., Lüdi, H., Widmer, H. M., Harrison, D. J., Trends Anal. Chem. 1991, 10, 144-149.

[3] Harrison, D. J., Manz, A., Fan, Z., Lüdi, H., Widmer, H. M., Anal. Chem. 1992, 64, 1926-1932.

[4] Manz, A., Harrison, D. J., Verpoorte, E., Fettinger, J. C., Paulus, A., Lüdi, H., Widmer, H. M., J. Chromatogr. 1992, 593, 253-258.

[5] Terry, S. C., Hernan, J. H., Angell, J. B., IEEE Trans. Electron Devices 1979, 26, 1880-1886.

[6] Jacobson, S. C., Hergenroder, R., Moore, A. W., Ramsey, J. M., Anal. Chem. 1994, 66, 4127-4132.

[7] Harrison, D. J., Flurri, K., Seiler, K., Fan, Z., Effenhauser, C. S., Manz, A., Science 1993, 261, 895-897.

[8] Oleschuk, R. D., Shultz-Lockyear, L. L., Ning, Y. B., Harrison, D. J., Anal. Chem. 2000, 72, 585-590.

[9] Jacobson, S. C., Moore, A. W., Ramsey, J. M., Anal. Chem. 1995, 67, 2059-2063.

10] Ocvirk, G., Verpoorte, E., Manz, A., Grasserbauer, M., Widmer, H. M., Anal. Methods Instrument. 1995, 2, 74-82.

[11] Ericson, C., Holm, J., Ericson, T., Hjertén, S., Anal. Chem 2000, 72, 81-87.

[12] He, B., Tait, N., Regnier, F., Anal. Chem. 1998, 70, 3790-3797.

[13] Kutter, J. P., Jacobsen, S. C., Matsubara, N., Ramsey, J. M., Anal. Chem. 1998, 70, 3291-3297.

[14] Quirino, J. P., Terabe, S., Science 1998, 282, 465-468.

[15] Moore, A. W., Jacobson, S. C., Ramsey, J. M., Anal Chem. 1995, 67, 4184-4189.

[16] Mao, Q. L., Pawliszyn, J., Analyst 1999, 124, 637-641.

[17] Jacobson, S. C., Koutny, L. B., Hergenroder, R., Moore, A. W., Ramsey, J. M., Anal Chem. 1994, 66, 3472-3476.

[18] Woolley, A. T., Lao, K. Q., Glazer, A. N., Mathies, R. A., Anal. Chem. 1998, 70, 684-688.

[19] Liang, Z. H., Chiem, N., Ocvirk, G., Tang, T., Fluri, K., Harrison, D. J., Anal. Chem. 1996, 68, 1040-1046.

[20] Crabtree, H. J., Kopp, M. U., Manz, A., Anal. Chem. 1999, 71, 2130-2138.

[21] Kopp, M. U., de Mello, A. J., Manz, A., Science 1998, 280, 1046-1048.

[22] Waters, L. C., Jacobson, S. C., Kroutchinina, N., Khandurina, J., Foote, R. S., Ramsey, J. M., Anal. Chem. 1998, 70, 158-162.

[23] Shi, Y. N., Simpson, P. C., Scherer, J. R., Wexler, D., Skibola, C., Smith, M. T., Mathies, R. A., Anal. Chem. 1999, 71, 5354-5361.

[24] Woolley, A. T., Sensabaugh, G. F., Mathies, R. A., Anal. Chem. 1997, 69, 2181-2186.

[25] Haab, B. B., Mathies, R. A., Anal. Chem. 1999, 71, 5137-5145.

[26] Rocklin, R. D., Ramsey, R. S., Ramsey, J. M., Anal. Chem. 2000, 72, 5244-5249.

[27] von Heeren, F., Verpoorte, E., Manz, A., Thormann, W., Anal Chem. 1996, 68, 2044-2053.

[28] Chiem, N., Harrison, D. J., Anal. Chem. 1997, 69, 373-378.

[29] Dolnik, V., Liu, S. R., Jovanovich, S., Electrophoresis 2000, 21, 41-54.

[30] Magnusson, P. K., Wilander, E., Gyllensten, U., BioTechniques 1996, 21, 844-847.

[31] Kulak, S. C., Kozlowski, K., Semina, E. V., Pearce, W. G., Walter, M. A., Hum. Mol. Genet. 1998, 7, 1113-1117.

[32] Kobayashi, M., Rappaport, E., Blasband, A., Semeraro, A., Sartore, M., Surrey, S., Fortina, P., Mol. Cell Probes 1995, 9, 175-182.

[33] Tian, H. J., Jaquins-Gerstl, A., Munro, N., Trucco, M., Brody, L. C., Landers, J. P., Genomics 2000, 63, 25-34.

[34] Schmalzing, D., Tsao, N., Koutny, L., Chisholm, D., Srivastava, A., Adourian, A., Linton, L., MeEwan, P., Matsudaira, P., Ehrlich, D., Genome Res. 1999, 9, 853-858.

[35] Backhouse, C., Caamano, M., Oaks, F., Nordman, E., Carrillo, A., Johnson, B., Bay, S., Electrophoresis 2000, 21, 150-156.

[36] Waters, L. C., Jacobsen, S. C., Kroutchinina, N., Khandurina, J., Foote, R. S., Ramsey, J. M., Anal. Chem. 1998, 70, 5172-5176.

[37] Khandurina, J., McKnight, T. E., Jacobson, S. C., Waters, L. C., Foote, R. S., Ramsey, J. M., Anal. Chem. 2000, 72, 2995-3000.

[38] Woolley, A. T., Hadley, D., Landre, P., deMello, A. J., Mathies, R. A., Northrup, M. A., Anal. Chem. 1996, 68, 4081-4086.

[39] Lagally, E. T., Simpson, P. C., Mathies, R. A., Sens. Actuator B 2000, 63, 138-146.

[40] Savitzky, A. Golay, M. J. E., Anal. Chem. 1964, 36, 1627-1639.

[41] Bard, A. J., Faulkner, L. R., Electrochemical Methods: Fundamentals and Applications, John Wiley and Sons, New York 1980.

[42] Dutta, P., Beskok, A., Anal Chem. 2001, 73, 1979-1986.

[43] Wang, J., Analytical Electrochemistry, Wiley-VCH, New York 2000.

[44] Paegel, B. M., Hutt, L. D., Simpson, P. C., Mathies, R. A., Anal. Chem. 2000, 72, 3030-3037.

[45] Khandurina, J., Jacobson, S. C., Waters, L. C., Foote, R. S., Ramsey, J. M., Anal. Chem. 1999, 71, 1815-1819.

[46] Kaniansky, D., Masar, M., Bielcikova, J., Ivanyi, F., Eisenbeiss, F., Stanislawski, B., Grass, B., Neyer, A., Johnck, M., Anal Chem. 2000, 72, 3596-3604.

[47] Walker, P. A., Morris, M. D., Burns, M. A., Johnson, B. N., Anal. Chem. 1998, 70, 3766-3769.

[48] Chou, C. F., Bakajin, O., Turner, S. W. P., Duke, T. A. J., Chan, S. S., Cox, E. C., Craighead, H. G., Austin, R. H., Proc. Natl. Acad. Sci. USA 1999, 96,13762-13765.

What is claimed is:

1. A method of sample separation, the method comprising the steps of:
moving product and contaminant along a first channel in a first direction at different speeds for the product and contaminant until the contaminant enters a waste well and the contaminant is diluted in the waste well; and
reversing the direction of movement of the product and contaminant to separate product from the contaminant.

2. The method of claim 1 in which the sample is obtained through polymerase chain reaction.

3. The method of claim 2 in which the product is DNA and the contaminant is PCR raw material.

4. The method of claim 1 in which the product and contaminant are moved by application of an electric potential along the channel.

5. The method of claim 4 in which the product is DNA, the contaminant is PCR raw material and the waste well is filled with running buffer.

6. The method of claim 1 further comprising detecting the product in the first channel.

7. A method of sample separation, the method comprising the steps of:
moving product and contaminant along a first channel in a first direction at different speeds for the product and contaminant until product and contaminant enter a waste well;
allowing dilution of contaminant in the waste well; and
reversing the direction of movement of the product and contaminant to separate product from the contaminant.

8. The method of claim 7 in which the sample is obtained through polymerase chain reaction.

9. The method of claim 8 in which the product is DNA and the contaminant is PCR raw material.

10. The method of claim 7 in which the product and contaminant are moved by application of an electric potential along the channel.

11. The method of claim 10 in which the product is DNA, the contaminant is PCR raw material and the waste well is filled with running buffer.

12. The method of claim 7 in which diluting the contaminant is achieved by diffusion during a pause in application of electrophoresis.

13. The method of claim 7 in which diluting the contaminant is achieved by rinsing the waste well.

14. A method of detecting product in a sample containing product and contaminant, the method comprising the steps of:
moving product and contaminant along a channel in a first direction at different speeds for the product and contaminant until product and contaminant enter a waste well;
diluting contaminant in the waste well;
reversing the direction of movement of the product and contaminant to separate product from the contaminant; and
detecting product at a detection point in the channel.

15. The method of claim 14 in which the channel is defined in a device and sample is obtained through polymerase chain reaction carried out on the device.

16. The method of claim 14 in which the product is DNA and the contaminant is PCR raw material.

17. The method of claim 14 in which the product and contaminant are moved by application of an electric potential along the channel.

18. The method of claim 17 in which the product is DNA, the contaminant is PCR raw material and the waste well is filled with running buffer.

19. The method of claim 14 further comprising isolating the separated product by drawing the separated product sample into a second channel intersecting the first channel.

20. The method of claim 14 in which diluting the contaminant is achieved by pausing movement of the contaminant to allow diffusion of the contaminant into the waste well.
